(19) United States
(12) Patent Application Publication
(10) Pub. No.: US 2023/0030304 A1
(43) Pub. Date: Feb. 2, 2023

(54) GLASS FILM MANUFACTURING METHOD AND GLASS FILM MANUFACTURING DEVICE

(71) Applicant: Nippon Electric Glass Co., Ltd., Shiga (JP)

(72) Inventors: Naohiro IKAI, Shiga (JP); Kenichi MURATA, Shiga (JP)

(21) Appl. No.: 17/789,277

(22) PCT Filed: Jan. 5, 2021
(86) PCT No.: PCT/JP2021/000099

§ 371 Date: Jun. 27, 2022

(30) Foreign Application Priority Data
Jan. 8, 2020 (JP) 2020-001527

(51) Int. Cl. C03B 33/09; C03B 35/18; B65H 20/10; B65H 20/12; B65H 23/032

(52) U.S. Cl. CPC C03B 33/091; C03B 35/189; B65H 20/10; B65H 20/12; B65H 23/032

(57) ABSTRACT

At the time of performing manufacture-related processing on a glass film (G1) with a manufacture-related-processing unit (9) while conveying the glass film (G1) with a belt conveyor (22d), the belt conveyor (22d) is configured to be capable of attracting the glass film (G1) to the belt (23d) on an upstream side in a conveyance direction of the glass film (G1) with respect to the manufacture-related-processing unit (9), and the belt conveyor (22d) is configured to be capable of changing attraction forces (P11 and P12) with respect to the glass film (G1) in a conveyance direction (X) of the glass film (G1).

### TECHNICAL FIELD

The present invention relates to a manufacturing method for a glass film, and a manufacturing apparatus for a glass film.

### BACKGROUND ART

In a manufacturing process for a glass film, in general, manufacture-related processing such as cutting and printing is performed on a glass film while conveying the glass film in a predetermined direction. At this time, in a region in which the manufacture-related processing is performed, or in a periphery of such region, the glass film is conveyed under a state of being attracted to a belt surface of a belt conveyor in some cases (see, for example, Patent Literature 1). Use of an attractable belt conveyor provides the following advantages. That is, a glass film can be conveyed with one surface of the glass film under a non-contact state, and the glass film can be stably held even when the conveyance is stopped.

### CITATION LIST

Patent Literature 1: JP 2018-150131 A

### SUMMARY OF INVENTION

### Technical Problem

Incidentally, in practice, it is sometimes very difficult to adjust an attraction force with respect to the glass film when the manufacture-related processing such as cutting is performed on the glass film while attracting and conveying the glass film by the belt conveyor as described above. The glass film is continuously conveyed along with driving of the belt. Thus, for example, when the attraction force with respect to the glass film is insufficient, an attraction state of the glass film may be eliminated during the conveyance. The elimination of the attraction state causes a binding force with respect to the glass film to be reduced or temporarily lost, with the result that misalignment with respect to the belt is more liable to occur. Meanwhile, when the attraction force with respect to the glass film is increased to strongly attract the glass film in order to avoid the elimination of the attraction state during the conveyance, the glass film is strongly bound depending on a degree of the attraction force. In this case, there is a problem in that deformation such as formation of wrinkles is liable to occur due to a speed difference with respect to surrounding.

In view of the circumstances described above, a technical problem to be solved by the present invention is to be capable of conveying a glass film without misalignment by maintaining an attraction state with respect to a belt while preventing deformation such as formation of wrinkles, and consequently performing favorable manufacture-related processing on the glass film.

### Solution to Problem

The problem described above is solved by a manufacturing method for a glass film according to the present invention. That is, there is provided the manufacturing method for a glass film, comprising, while conveying a glass film with a belt conveyor, performing manufacture-related processing on the glass film with a manufacture-related-processing unit, wherein the belt conveyor is configured to be capable of attracting the glass film to a belt on an upstream side in a conveyance direction of the glass film with respect to the manufacture-related-processing unit, and wherein the belt conveyor is configured to be capable of changing attraction forces with respect to the glass film in the conveyance direction of the glass film.

As described above, in the manufacturing method for a glass film according to the present invention, at least a predetermined part of the belt conveyor has the structure capable of attracting the glass film to the belt, and the attraction forces with respect to the glass film on the belt conveyor can be changed in the conveyance direction of the glass film. With such configuration, the glass film can be conveyed while being attracted by attraction forces having appropriate magnitudes depending on positions thereof in the conveyance direction. Thus, when there is a location in which the glass film is excessively strongly attracted, the attraction force in that location is set to be smaller so that deformation such as formation of wrinkles can be prevented or suppressed as much as possible. Meanwhile, with regard to other locations, for example, the attraction force is set to be relatively larger so that slippage of the glass film with respect to the belt is prevented, thereby being capable of conveying the glass film without misalignment.

Further, in a manufacturing method for a glass film according to the present invention, when viewed in the conveyance direction of the glass film, an attraction force with respect to the glass film may be relatively smaller on a side close to the manufacture-related-processing unit, and an attraction force with respect to the glass film may be relatively larger on a side far from the manufacture-related-processing unit.

With regard to the deformation such as formation of wrinkles, it is important that, even when the deformation such as formation of wrinkles has occurred during conveyance, the deformation such as formation of wrinkles is eliminated or reduced at the time of performing manufacture-related processing which is highly likely to influence a final quality (at the time of passing through the location in which the manufacture-related processing is performed). In this regard, when the attraction force with respect to the glass film is set so as to be relatively smaller on the side close to the manufacture-related-processing unit, and the attraction force with respect to the glass film is set so as to be relatively larger on the side far from the manufacture-related-processing unit, the glass film is strongly attracted on the upstream side with respect to the manufacture-related-processing unit so that the glass film can be conveyed without misalignment. Further, even when the deformation such as formation of wrinkles has occurred at the time of strongly attracting the glass film, with the attraction force being set to be relatively smaller in a region on the downstream side with respect to the location in which the deformation such as formation of wrinkles has occurred and on the upstream side with respect to the manufacture-related-processing unit, the deformation such as formation of wrinkles which has once occurred can be eliminated or reduced before arrival at the manufacture-related-processing unit. In this manner, the glass film can be loaded into the manufacture-related-processing unit under a state of having no misalignment and no deformation such as formation of wrinkles, thereby being capable of more stably performing high-quality manufacture-related processing.

Further, in a manufacturing method for a glass film according to the present invention, an attraction surface of the belt capable of attracting the glass film may be divided into a plurality of attraction zones capable of varying attraction forces with respect to the glass film in the conveyance direction of the glass film.

When the attraction surface of the belt is divided into the plurality of attraction zones in the conveyance direction of the glass film as described above, it is only required that the attraction forces be set for the attraction zones. Thus, for example, as compared to a case in which the attraction forces are continuously varied in the conveyance direction, the attraction force distribution with respect to the glass film can easily be set or changed. Further, the attraction surface is divided into the plurality of attraction zones in the conveyance direction. Thus, an attraction mechanism can also be formed in a relatively easier manner. Accordingly, it is preferred also in terms of equipment cost.

Further, in a case in which an attraction surface is divided into a plurality of attraction zones, in the manufacturing method for a glass film according to the present invention, the attraction surface may be divided into two attraction zones in the conveyance direction of the glass film. Further, in this case, magnitudes of the attraction forces in the attraction zones may be controlled such that the attraction force in a first attraction zone of the attraction surface located on an upstream side in the conveyance direction of the glass film is relatively larger and that the attraction force in a second attraction zone of the attraction surface located on a downstream side in the conveyance direction of the glass film with respect to the first attraction zone is relatively smaller.

As mentioned above, in the case in which the attraction surface of the belt is divided into the two attraction zones, when the attraction force in the attraction zone located on the upstream side in the conveyance direction (first attraction zone) is set to be relatively larger, and the attraction force in the attraction zone located on the downstream side in the conveyance direction (second attraction zone) is set to be relatively smaller, as described above, the glass film is strongly attracted in the first attraction zone so that the glass film can be conveyed without misalignment. Further, even when the deformation such as formation of wrinkles has occurred at the time of strongly attracting the glass film in the first attraction zone, with the attraction force being set to be relatively smaller in the region on the downstream side in the conveyance direction with respect to the location in which the deformation such as formation of wrinkles has occurred, the deformation such as formation of wrinkles that has once occurred can be eliminated or reduced. In this manner, the glass film can be conveyed under a state of having no misalignment and no deformation such as formation of wrinkles. Thus, for example, when the manufacture-related-processing unit is arranged on the second attraction zone or on the downstream side in the conveyance direction with respect to the second attraction zone, high-quality manufacture-related processing can be stably performed. Further, it is only required that the attraction forces be set for the two attraction zones. Thus, the attraction force distribution can easily be set or changed.

Further, in a case in which an attraction surface is divided into a plurality of attraction zones, in the manufacturing method for a glass film according to the present invention, the attraction surface may be divided into three attraction zones in the conveyance direction of the glass film. Further, in this case, when the three attraction zones comprise a first attraction zone, a second attraction zone, and a third attraction zone which are arranged in the stated order from an upstream side toward a downstream side in the conveyance direction of the glass film, magnitudes of the attraction forces in the attraction zones may be controlled such that the attraction force in the second attraction zone is the largest and that the attraction forces in the first attraction zone and the third attraction zone are each smaller than the attraction force in the second attraction zone.

As mentioned above, when the attraction surface of the belt is divided into the three attraction zones, among the attraction forces in the three attraction zones, the attraction force in the attraction zone located in the middle in the conveyance direction (second attraction zone) is set to be the largest, and the attraction force in the attraction zone on the downstream side in the conveyance direction (third attraction zone) with respect to the second attraction zone and the attraction force in the attraction zone on the upstream side in the conveyance direction (first attraction zone) with respect to the second attraction zone are each set to be smaller than the attraction force in the second attraction zone. After being formed, the glass film is subjected to various processing as needed. After that, the glass film is transferred from, for example, another conveyor to the belt conveyor according to the present invention and placed thereon. Thus, at the time of the transfer and placement, when an attempt is made to strongly attract the glass film, there is a problem in that deformation such as formation of wrinkles is liable to occur. Meanwhile, when the attraction force in the attraction zone on the most upstream side is set to be relatively smaller, occurrence of the deformation such as formation of wrinkles immediately after the transfer and placement as mentioned above can be prevented. In this manner, the glass film can be conveyed to the manufacture-related-processing unit under a state of having no deformation such as formation of wrinkles in the glass film after the transfer and placement. Further, while the glass film is strongly attracted in the second attraction zone so that the glass film is conveyed without misalignment, when the attraction force is set to be relatively smaller in the attraction zone (third attraction zone) on the downstream side in the conveyance direction with respect to the second attraction zone, even when deformation such as formation of wrinkles has newly occurred in the second attraction zone, the deformation such as formation of wrinkles can be eliminated or reduced. In this manner, the glass film can be conveyed under a state of having no misalignment and no deformation such as formation of wrinkles. Thus, for example, when the manufacture-related-processing unit is arranged on the third attraction zone or on the downstream side in the conveyance direction with respect to the third attraction zone, high-quality manufacture-related processing can be stably performed. Further, it is only required that the attraction forces for the three attraction zones be set. Thus, the attraction force distribution can easily be set.

Further, in a case in which an attraction surface is divided into a plurality of attraction zones, in the manufacturing method for a glass film according to the present invention, the belt conveyor further may comprise a support member having a hollow shape and being configured to support the belt, the support member comprises therein an air-discharge space capable of discharging air, and the air-discharge space is partitioned so as to correspond to the attraction zones in the conveyance direction of the glass film, and the support member and the belt may comprise a communication portion configured to allow communication between the air-discharge space and a space defined between the belt and the support member.

With such configuration, a part of the upper surface of the belt passing above a part of the support member having the air-discharge space functions as the attraction surface with respect to the glass film. Further, the air-discharge space is partitioned so as to correspond to the attraction zones. Thus, through adjustment of the air-discharge amounts in the partitioned spaces (as well as magnitudes of the negative pressure generated in the partitioned spaces), attraction zones which may exert predetermined attraction forces, respectively, on the belt can be formed. With the configuration described above, it is only required that least improvement be made on the support member having hitherto been present. Thus, a desired attraction force distribution can be formed on the belt at low cost as much as possible while avoiding an increase in size and complication of the apparatus.

Further, in a case in which the air-discharge space in the support member is partitioned so as to correspond to the attraction zones, in the manufacturing method for a glass film according to the present invention, blowers which are independently controllable may be connected to partitioned spaces defined by partitioning the air-discharge space, respectively.

The air-discharge amounts in the partitioned spaces can be adjusted also by, for example, connecting one blower to a corresponding one of the partitioned spaces of the air-discharge space and mounting a valve between each partitioned space and the blower. However, in this way, it is difficult to accurately adjust the attraction force. Meanwhile, according to the present invention, the blowers are connected to the partitioned spaces, respectively. Thus, the air-discharge amount as well as the negative pressure in each partitioned space can be accurately controlled in a convenient and highly accurate manner by, for example, only adjusting a frequency of a motor being a power source for the blower.

Further, in the manufacturing method for a glass film according to the present invention, the belt conveyor may comprise an upstream-side belt conveyor located relatively on an upstream side in the conveyance direction of the glass film, and a downstream-side conveyor may be arranged on a downstream side in the conveyance direction of the glass film with respect to the upstream-side belt conveyor.

When the downstream-side conveyor is arranged in such a manner, when the glass film has a strip shape, a pulling force can be applied to a part passing the downstream side of the belt conveyor having the attraction structure. Accordingly, the deformation such as formation of wrinkles that has occurred in the glass film can be eliminated or suppressed more effectively, thereby being capable of more reliably loading the glass film into the manufacture-related-processing unit under a state of having no deformation such as formation of wrinkles.

Further, according to the manufacturing method for a glass film described above, the attraction state with respect to the belt is maintained while preventing the deformation such as formation of wrinkles so that the glass film can be conveyed without misalignment, thereby being capable of performing favorable manufacture-related processing on the glass film. Thus, for example, in a case in which the manufacture-related-processing unit comprises a laser cutting unit capable of cutting the glass film along a longitudinal direction of the glass film, the present invention is preferred. That is, when the present invention is applied to the laser cutting on the glass film conveyed by the belt conveyor, accurate cutting on the glass film can be stably performed.

The problem described above is solved by a manufacturing method for a glass film according to the present invention. That is, there is provided the manufacturing apparatus for a glass film, comprising: a belt conveyor configured to convey a glass film; and a manufacture-related-processing unit configured to perform manufacture-related processing on the glass film being conveyed by the belt conveyor, wherein the belt conveyor is configured to be capable of attracting the glass film to a belt on an upstream side in a conveyance direction of the glass film with respect to the manufacture-related-processing unit, and wherein the belt conveyor is configured to be capable of changing an attraction force with respect to the glass film in the conveyance direction of the glass film.

As described above, also in the manufacturing apparatus for a glass film according to the present invention, at least a predetermined part of the belt conveyor has the structure capable of attracting the glass film to the belt, and the attraction forces with respect to the glass film on the belt conveyor can be changed in the conveyance direction of the glass film. With such configuration, the glass film can be conveyed while being attracted by attraction forces having appropriate magnitudes depending on positions thereof in the conveyance direction. Thus, when there is a location in which the glass film is excessively strongly attracted, the attraction force in that location is set to be smaller so that deformation such as formation of wrinkles can be prevented or suppressed as much as possible. Meanwhile, with regard to other locations, for example, the attraction force is set to be relatively larger so that slippage of the glass film with respect to the belt can be prevented, thereby being capable of conveying the glass film without misalignment.

### Advantageous Effects of Invention

As mentioned above, according to the present invention, the attraction state with respect to the belt is maintained while preventing the deformation such as formation of wrinkles so that the glass film can be conveyed without misalignment, thereby being capable of performing favorable manufacture-related processing on the glass film.

### BRIEF DESCRIPTION OF DRAWINGS

FIG. 1 is a side view for illustrating an overall configuration of a manufacturing apparatus for a glass film according to a first embodiment of the present invention.

FIG. 2 is a plan view of a conveying device illustrated in FIG. 1.

FIG. 3 is a side view of the conveying device illustrated in FIG. 2.

FIG. 4 is a main-part sectional view of the conveying device taken along the cutting line A-A of FIG. 2.

FIG. 5 is a graph for showing a relationship between conveyance-direction positions and attraction forces in the conveying device illustrated in FIG. 4.

FIG. 6 is a main-part sectional view of a conveying device according to a second embodiment of the present invention.

FIG. 7 is a graph for showing a relationship between conveyance-direction positions and attraction forces in the conveying device illustrated in FIG. 6.

FIG. 8 is a main-part sectional view of an attraction-force control system according to a third embodiment of the present invention, and is a main-part sectional view taken along the cutting line B-B of FIG. 2.

FIG. 9 is a graph for showing a relationship between conveyance-direction positions and attraction forces in a conveying device according to the third embodiment of the present invention.

### DESCRIPTION OF EMBODIMENTS

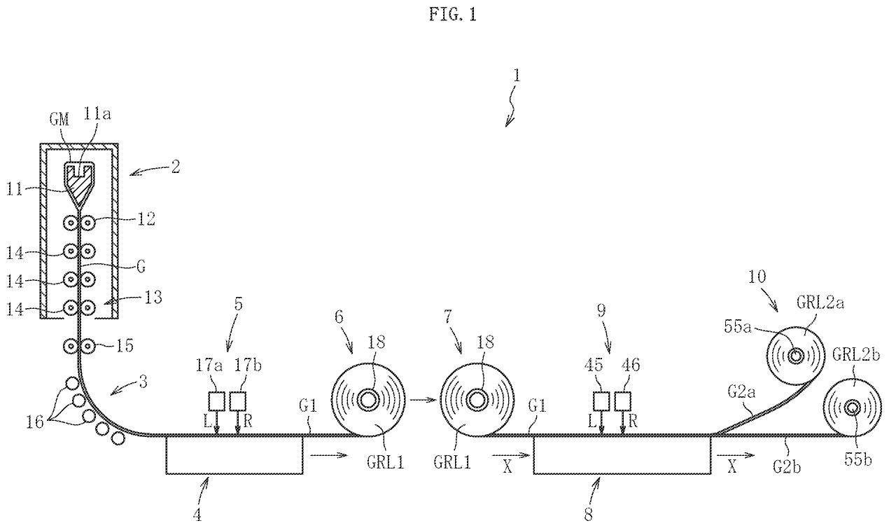

Now, a manufacturing method for a glass film according to a first embodiment of the present invention is described with reference to FIG. 1 to FIG. 5. In the following, description is made of an example case in which a glass film is rolled into a roll shape to finally obtain a glass roll.

As illustrated in FIG. 1, a manufacturing apparatus 1 for a glass film (glass roll) according to one embodiment of the present invention comprises: a forming portion 2 configured to form a strip-shaped base glass film G; a direction conversion portion 3 configured to convert a traveling direction of the base glass film G from a vertically downward direction to a lateral direction; a first conveying portion 4 configured to convey the base glass film G in the lateral direction after the direction conversion; a first cutting portion 5 configured to cut both end portions of the base glass film G in a width direction; and a first roll-up portion 6 configured to roll up a glass film (hereinafter referred to as “first glass film”) G1, which is obtained by removing the both end portions in the width direction, into a roll shape to obtain a first glass roll GRL1. In this embodiment, a longitudinal direction is a vertical direction, and a lateral direction is a horizontal direction.

Further, the manufacturing apparatus 1 for a glass roll further comprises: a draw-out portion 7 configured to draw out the first glass film G1 from the first glass roll GRL1; a second conveying portion 8 configured to convey the first glass film G1, which has been drawn out from the draw-out portion 7, in the lateral direction; a second cutting portion 9 configured to cut part of the first glass film G1; and a second roll-up portion 10 configured to roll up glass films (hereinafter referred to as “second glass films”) G2a and G2b, which are obtained through the cutting by the second cutting portion 9, into a roll shape to obtain second glass rolls GRL2a and GRL2b. The second cutting portion 9 in this embodiment corresponds to a manufacture-related-processing unit according to the present invention.

The forming portion 2 comprises: a forming body 11 having a substantially wedge shape in sectional view in which an overflow groove 11a is formed on an upper end portion thereof; edge rollers 12 arranged immediately below the forming body 11 and configured to sandwich a molten glass GM overflowing from the forming body 11 from both front and back surface sides of the molten glass GM; and an annealer 13 arranged immediately below the edge rollers 12.

The forming portion 2 is configured to cause the molten glass GM overflowing from the overflow groove 11a of the forming body 11 to flow down along both side surfaces of the forming body 11 to be joined at a lower end portion of the forming body 11, to thereby form the molten glass GM into a film shape. The edge rollers 12 are configured to control shrinkage of the molten glass GM in a width direction to adjust the dimension in the width direction of the base glass film G. The annealer 13 is configured to perform strain removal treatment on the base glass film G. The annealer 13 comprises annealer rollers 14 arranged in a plurality of stages in a vertical direction.

Support rollers 15 configured to sandwich the base glass film G from both the front and back surface sides are arranged below the annealer 13. A tension for encouraging thinning of the base glass film G is applied between the support rollers 15 and the edge rollers 12 or between the support rollers 15 and the annealer rollers 14 at any one position.

The direction conversion portion 3 is arranged at a position below the support rollers 15. In the direction conversion portion 3, a plurality of guide rollers 16 configured to guide the base glass film G are arranged in a curved form. Those guide rollers 16 are configured to guide the base glass film G, which has been conveyed in the vertical direction, in the lateral direction.

The first conveying portion 4 is arranged in a forward traveling direction with respect to (on a downstream side of) the direction conversion portion 3. When a driving portion having a support conveyance surface is driven, the first conveying portion 4 conveys the base glass film G, which has passed through the direction conversion portion 3, to a downstream side along a longitudinal direction of the base glass film G. The first conveying portion 4 may have a suitable configuration, and may include, for example, one or a plurality of belt conveyors. In this case, the driving portion having the support conveyance surface is a belt. The base glass film G can be conveyed in the above-mentioned mode by driving the belt. As a matter of course, a configuration of the first conveying portion 4 is not limited to that exemplified above. Other various types of conveying devices such as a roller conveyor may also be used.

The first cutting portion 5 is arranged above the first conveying portion 4. In this embodiment, the first cutting portion 5 is configured so as to be capable of cutting the base glass film G by laser cleavage. Specifically, the first cutting portion 5 comprises: a pair of laser irradiation devices 17a; and a pair of cooling devices 17b arranged on a downstream side of the laser irradiation devices 17a. The first cutting portion 5 is configured to, while the base glass film G is conveyed, heat a predetermined site of the base glass film G through irradiation with a laser beam L from the laser irradiation device 17a, and then release a refrigerant R from the cooling device 17b to cool the heated site.

The first roll-up portion 6 is arranged on a downstream side of the first conveying portion 4 and the first cutting portion 5. The first roll-up portion 6 is configured to roll up the first glass film G1 into a roll shape by rotating a winding core 18. The first glass roll GRL1 obtained as described above is conveyed to the position of the draw-out portion 7. The draw-out portion 7 is configured to draw out the first glass film G1 from the first glass roll GRL1 having been obtained by the first roll-up portion 6, and supply the first glass film G1 to the second conveying portion 8.

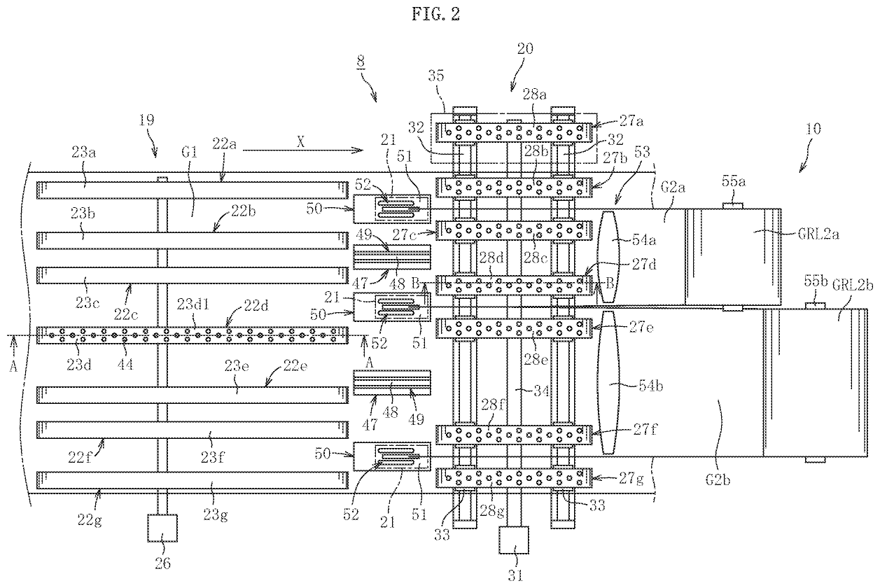

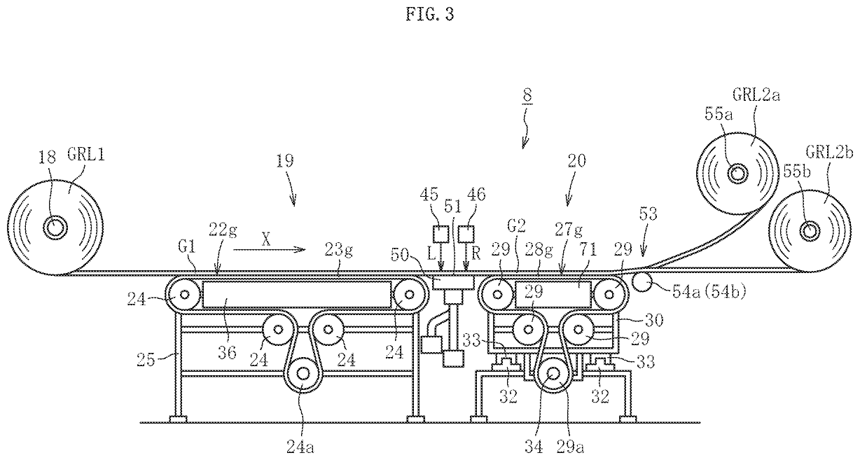

The second conveying portion 8 conveys the first glass film G1, which has been drawn out from the first glass roll GRL1 by the draw-out portion 7, in a lateral direction (hereinafter referred to as “conveying direction X”). Here, as illustrated in FIG. 2 and FIG. 3, the second conveying portion 8 comprises an upstream-side conveyor 19 and a downstream-side conveyor 20. The upstream-side conveyor 19 is located relatively on an upstream side in the conveyance direction of the first glass film G1. The downstream-side conveyor 20 is located on a downstream side in the conveyance direction of the first glass film G1 with respect to the upstream-side conveyor 19. In this case, the second cutting portion 9 being the manufacture-related-processing unit is arranged between the upstream-side conveyor 19 and the downstream-side conveyor 20. Thus, cutting zones 21 (regions surrounded by one-dot chain lines of FIG. 2) for the first glass film G1 by the second cutting portion 9 are absent on both of a support conveyance surface of the upstream-side conveyor 19 and a support conveyance surface of the downstream-side conveyor 20.

The upstream-side conveyor 19 comprises a belt conveyor. In this case, the upstream-side conveyor 19 corresponds to a belt conveyor according to the present invention. In this embodiment, the upstream-side conveyor 19 comprises a plurality of upstream-side belt conveyors 22a to 22g. The plurality of upstream-side belt conveyors 22a to 22g are configured to convey the first glass film G1 to a downstream side while supporting the first glass film G1 in a contact manner by belts (hereinafter referred to as “first belts 23a to 23g”) in the same direction. Here, each of the first belts 23a to 23g is, for example, an endless strip-shaped belt. The first belts 23a to 23g are set at the same height positions so as to keep the first glass film G1 in a substantially horizontal posture over its entire region in the longitudinal direction in which the first belts 23a to 23g are in contact with the first glass film G1.

Here, the upstream-side belt conveyors 22a to 22g have the same belt driving structure. As exemplified in the upstream-side belt conveyor 22g located on the most one end side in the width direction (lower side of FIG. 2), as illustrated in FIG. 3, the upstream-side belt conveyor 22g comprises: the above-mentioned endless strip-shaped first belt 23g; a plurality of pulleys 24 for arranging the first belt 23g at a predetermined position while applying a tension to the first belt 23g; and a first support member 25 configured to support the plurality of pulleys 24. The first support member 25 is fixed onto a floor surface. Further, a drive source 26 such as a motor is coupled to a predetermined pulley 24 (drive pulley 24a) of the plurality of pulleys 24 (see FIG. 2). When a driving force is applied to the drive pulley 24a by the drive source 26, the first belt 23g of each of the upstream-side belt conveyor 22g can be driven in a predetermined direction.

Further, the plurality of upstream-side belt conveyors 22a to 22g, each having the above-mentioned configuration, are installed at predetermined positions in the width direction. In this case, supposing that a plurality of kinds of first glass films G1 having different dimensions in the width direction are conveyed on the upstream-side conveyor 19, positions of the first belts 23a to 23g in the width direction are set so as to be able to support both ends of the first glass films G1, which are supposed to be conveyed, in the width direction in a contact manner. Further, in this embodiment, the upstream-side belt conveyor 22d is disposed so as to support all the first glass films G1 at center positions in the width direction in a contact manner independently of magnitudes of their dimensions in the width direction (see FIG. 2). In this embodiment, the upstream-side belt conveyor 22d located at the center in the width direction is configured to be capable of attracting the first glass film G1 to a surface (attraction surface 23d1) of the first belt 23d being the support conveyance surface. This attraction structure is described later. Further, in this embodiment, the remaining upstream-side belt conveyors 22a to 22c and 22e to 22g do not have the attraction structure (are configured so as not to be capable of attracting) as can be understood from the fact that the surfaces of the first belts 23a to 23c and 23e to 23g are flat and smooth.

In this embodiment, the downstream-side conveyor 20 comprises a belt conveyor. In this case, the downstream-side conveyor 20 comprises a plurality of downstream-side belt conveyors 27a to 27g. Each of the plurality of downstream-side belt conveyors 27a to 27g is configured to convey the first glass film G1 obtained by cutting, that is, second glass films G2a and G2b, to a downstream side while supporting the first glass film G1 in a contact manner by a belt (hereinafter referred to as “second belts 28a to 28g”) in the same direction. In this case, each of the second belts 28a to 28g is, for example, an endless strip-shaped belt. The second belts 28a to 28g are set at the same height positions so as to keep the second glass films G2a and G2b in a substantially horizontal posture over its entire region in the longitudinal direction in which the second belts 28a to 28g are in contact with the second glass films G2a and G2b.

Here, the downstream-side belt conveyors 27a to 27g have the same belt driving structure. As exemplified in the downstream-side belt conveyor 27g located on the most one end side in the width direction (lower side of FIG. 2), as illustrated in FIG. 3, the downstream-side belt conveyor 27g comprises: the above-mentioned endless strip-shaped second belts 28a to 28g; a plurality of pulleys 29 for arranging the second belts 28a to 28g at a predetermined position while applying a tension to the second belts 28a to 28g; and a first support member 30 configured to support the plurality of pulleys 29. Further, a drive source 31 such as a motor is coupled to a predetermined pulley 29 (drive pulley 29a) of the plurality of pulley 29 (see FIG. 2). When a driving force is applied to the drive pulley 29a by the drive source 31, the second belts 28a to 28g of each of the downstream-side belt conveyors 27a to 27g can be driven in a predetermined direction. The drive source 31 is provided separately from and independently of the drive source 26 for the upstream-side belt conveyors 22a to 22g. The drive sources 26 and 31 can be independently controlled without being associated with each other, which in turn enables individual control of driving of the upstream-side belt conveyors 22a to 22g and the downstream-side belt conveyors 27a to 27g.

Further, in this embodiment, the plurality of downstream-side belt conveyors 27a to 27g can be installed at predetermined positions in the width direction. At the same time, a position of each of the second belts 28a to 28g is adjustable in the width direction of the first glass film G1. More specifically, rail portions 32 extending in the width direction of the first glass film G1 are disposed below each of the downstream-side belt conveyors 27a to 27g. Sliding portions 33 are mounted to a lower part of the first support member 30 of each of the downstream-side belt conveyors 27a to 27g. The sliding portions 33 are movable relative to the rail portions 32. As a result, when the sliding portions 33 mounted to each of the first support members 30 slide in the width direction with respect to the rail portions 32, the plurality of pulleys 29 supported by each of the first support members 30 and the second belts 28a to 28g supported by the pulleys 29 can slide together in the width direction. The drive pulley 29a of each of the downstream-side belt conveyors 27a to 27g is supported so as to be slidable in the width direction with respect to a shaft 34 common to the downstream-side belt conveyors 27a to 27g. Thus, the drive pulley 29a can receive a driving force from the drive source 31 to be driven at a suitable position in the width direction while allowing a free change in its position in the width direction with respect to the shaft 34. In the illustrated example, the downstream-side belt conveyor 27a located on the most another end side in the width direction (most upper side of FIG. 2) is arranged at a position (retreat space 35) apart from the conveyance paths for the second glass films G2a and G2b in the width direction.

Further, in this embodiment, as illustrated in FIG. 2, all of the second belts 28a to 28g of the downstream-side belt conveyors 27a to 27g are configured to be capable of attracting the second glass films G2a and G2b to respective surfaces being support conveyance surfaces.

Next, the attraction structure of the upstream-side belt conveyor 22d is described in detail.

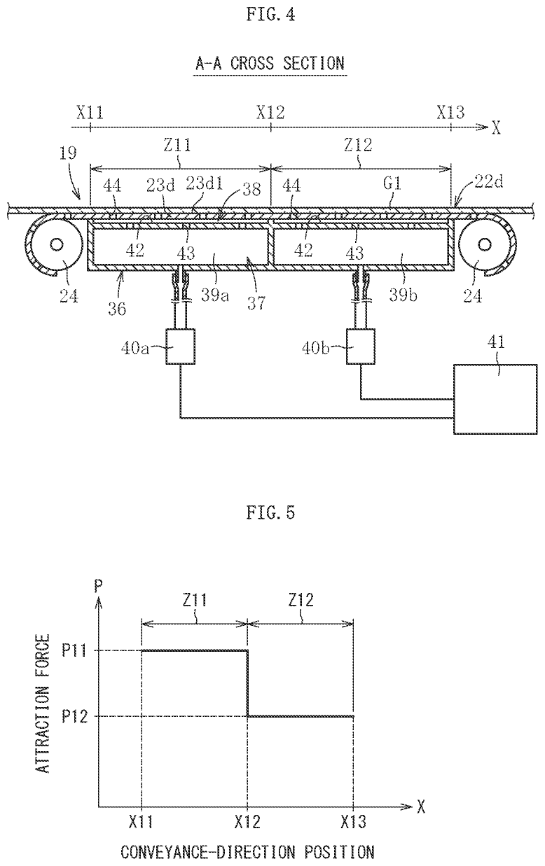

As mentioned above, the upstream-side belt conveyor 22d comprises the endless strip-shaped first belt 23d, the plurality of pulleys 24, the first support member 25, and the drive source 26 (see FIG. 2 and FIG. 3). Further, as illustrated in FIG. 4, the upstream-side belt conveyor 22d comprises: a second support member 36 configured to support the first belt 23d from below; an air-discharge space 37; and a communication portion 38 configured to allow communication between the air-discharge space 37 and a space defined between the first belt 23d and the second support member 36.

The second support member 36 is mounted to the first support member 25 so as to be fixed to the floor surface. In this embodiment, the second support member 36 comprises a frame-like member having a hollow shape, for example, a rectangular pipe. In this case, the air-discharge space 37 is defined inside the second support member 36. The air-discharge space 37 is partitioned into a plurality of spaces in the conveyance direction of the first glass film G1. Here, the air-discharge space 37 is partitioned into two spaces (first partitioned space 39a and second partitioned space 39b). In this case, the partitioned spaces 39a and 39b are connected to blowers 40a and 40b, respectively, each serving as an air-discharge device. The plurality of blowers 40a and 40b can be independently controlled by a controller 41. Details of a control mode is described later in detail.

Further, in this case, the communication portion 38 comprises one or a plurality of groove portions 42, hole portions 43, and a plurality of through holes 44. The one or the plurality of groove portions 42 are formed in an upper surface of the second support member 36, and extend along a longitudinal direction of the first belt 23d. The hole portions 43 are formed in the second support member 36, and allow communication between the groove portions 42 and each of the partitioned spaces 39a and 39b of the air-discharge space 37. The plurality of through holes 44 are formed in the first belt 23d, and are formed at positions overlapping the groove portions 42 in the width direction of the first belt 23d. Thus, when discharge of air from the partitioned spaces 39a and 39b is performed by driving of the blowers 40a and 40b, a downward suction force acts on the first glass film G1 on the first belt 23d through the groove portions 42, the hole portions 43, and the through holes 44, thereby being capable of attracting the first glass film G1 to the first belt 23d. In this manner, a part of the surface of the first belt 23d passing above the air-discharge space 37 functions as the attraction surface 23d1 with respect to the first glass film G1. Further, as mentioned above, when the air-discharge space 37 is partitioned into a plurality of spaces in the longitudinal direction of the first glass film G1, the attraction surface 23d1 of the first belt 23d is divided into a plurality of attraction zones Z11 and Z12 which are capable of varying the attraction forces with respect to the first glass film G1 in predetermined regions in a conveyance direction X of the first glass film G1. In this case, the attraction zones Z11 and Z12 are set to positions and sizes corresponding to the partitioned spaces 39a and 39b located therebelow. In this embodiment, as illustrated in FIG. 4, the positions and the sizes of the partitioned spaces 39a and 39b are set such that a dimension of the first attraction zone Z11 in the direction along the conveyance direction X and a dimension of the second attraction zone Z12 in the direction along the conveyance direction X are equal to each other. Further, although illustration is omitted, the positions and sizes of the partitioned spaces 39a and 39b are set such that a width-direction dimension of the first attraction zone Z11 and a width-direction dimension of the second attraction zone Z12 are equal to each other.

The upstream-side belt conveyor 22d having the above-mentioned attraction structure is configured to be capable of changing the attraction forces with respect to the first glass film G1 depending on positions in its longitudinal direction, in other words, depending on positions in the conveyance direction X of the first glass film G1. As in this embodiment, when the blowers 40a and 40b are connected for the partitioned spaces 39a and 39b, respectively, and the blowers 40a and 40b are configured to be controllable by the controller 41, for example, through adjustment of outputs (air-discharge amounts) of the blowers 40a and 40b by the controller 41, the negative pressures inside the partitioned spaces 39a and 39b as well as the attraction forces with respect to the first glass film G1 are independently set for the attraction zones Z11 and Z12 formed and set above the partitioned spaces 39a and 39b. As described above, the outputs of the blowers 40a and 40b are controlled by the controller 41 such that the attraction forces with respect to the first glass film G1 vary in the two attraction zones Z11 and Z12.

FIG. 5 is a graph for showing a relationship between the attraction zones Z11 and Z12 and attraction forces P11 and P12 according to this embodiment. As shown in FIG. 5, when the upstream-side belt conveyor 22d has the above-mentioned configuration, for example, in a section from a position X11, which is an upstream end of the first attraction zone Z11, to a position X12 on the conveyance direction X (see FIG. 4), a relatively large attraction force P11 acts on the first glass film G1. In this case, the attraction force P11 is set to a constant magnitude (equally) in the section from the position X11 to the position X12. Further, in a section from the position X12, which is an upstream end of the second attraction zone Z12, to a position X13 (see FIG. 4) on the conveyance direction X, a relatively smaller attraction force P12 acts on the first glass film G1. In this case, the attraction force P12 is set to a constant magnitude in the section from the position X12 to the position X13. In this case, it is preferred that a difference between the attraction force P11 in the first attraction zone Z11 and the attraction force P12 in the second attraction zone Z12 be from 1 kPa to 1.5 kPa. As described above, in this embodiment, the drive control on the blowers 40a and 40b by the controller 41 is performed such that, when seen in the conveyance direction X of the first glass film G1, the attraction force P12 with respect to the first glass film G1 is relatively smaller on the side close to the second cutting portion 9 (second attraction zone Z12) and that the attraction force P11 with respect to the first glass film G1 is relatively larger on the side far from the second cutting portion 9 (first attraction zone Z11).

The second cutting portion 9 is arranged above a region of the second conveying portion 8, which is located between the upstream-side conveyor 19 and the downstream-side conveyor 20 (see FIG. 1 and FIG. 3). In this embodiment, the second cutting portion 9 is configured to cut the first glass film G1 by laser cleavage. The second cutting portion 9 comprises a plurality of laser irradiation devices 45 and cooling devices 46. The cooling device 46 is arranged on a downstream side of each of the laser irradiation devices 45. In this case, the cooling devices 46 as many as the laser irradiation devices 45 are arranged. In this embodiment, three cutting zones 21 where the first glass film G1 is cut by the second cutting portion 9 are set in the width direction (see FIG. 2). Thus, three laser irradiations devices 45 and three cooling devices 46 are provided. The second cutting portion 9 having the above-mentioned configuration is configured to irradiate predetermined areas of the first glass film G1, which is being conveyed, with laser beams L emitted from the laser irradiation devices 45 to heat the predetermined areas and then discharge the refrigerant R from the cooling devices 46 to cool the heated areas.

Further in this embodiment, as illustrated in FIG. 2, first surface plates 47 are disposed at positions separate from the above-mentioned cutting zones 21 for the first glass film G1 in the width direction. The first surface plates 47 can support the first glass film G1, which is being conveyed by the second conveying portion 8, in a contact manner. More specifically, the first surface plates 47 are disposed at positions corresponding to centers of the first glass film G1 after cutting (the second glass films G2a and G2b) in the width direction. In this embodiment, two second glass films G2a and G2b are cut out of one first glass film G1. Thus, the first surface plates 47 are disposed at positions that are in the width direction with respect to the cutting zones 21 and correspond to centers of the second glass films G2a and G2b in the width direction. Although not shown, these first surface plates 47 are installed and fixed onto the floor surface, and are always in a stationary state.

Further, as illustrated in FIG. 2, each of the first surface plates 47 comprises a first support surface 48 and a first suction portion 49. The first support surface 48 can support the first glass film G1 in a contact manner. The first suction portion 49 can suck the first glass film G1 toward the first support surface 48. With the first suction portion 49, when the first glass film G1 is conveyed on the first support surface 48 of the first surface plate 47, the first glass film G1 can be sucked with respect to the first support surface 48.

Further, in this embodiment, as illustrated in FIG. 2, second surface plates 50 are disposed so as to include the above-mentioned cutting zones 21 for the first glass film G1. The second surface plates 50 can support the first glass film G1 in a contact manner. In this embodiment, the first glass film G1 is cut at three positions in the width direction. Thus, three second surface plates 50 are disposed for three cutting zones 21, respectively. Although not shown, these second surface plates 50 are installed and fixed onto the floor surface, and are always in a stationary state.

In this case, as illustrated in FIG. 2, each of the second surface plates 50 comprises a second support surface 51 and a second suction portion 52. The second support surface 51 can support the first glass film G1 in a contact manner. The second suction portion 52 can suck the first glass film G1 toward the second support surface 51. With the second suction portion 52, when the first glass film G1 is conveyed on the second support surface 51 of the second surface plate 50, the first glass film G1 can be sucked with respect to the second support surface 51.

A spacing portion 53 is provided on a downstream side of the second conveying portion 8. The spacing portion 53 spaces one set of the second glass films G2a and G2b apart from each other in the width direction. The second glass films G2a and G2b are adjacent to each other in the width direction. In this embodiment, the spacing portion 53 comprises support rollers 54a and 54b. The support rollers 54a and 54b each have a barrel-like shape with the largest diameter at a center in the width direction so that the second glass films G2a and G2b are deformed so as to curve in a direction of protruding upward and curved in an upwardly convex manner. In this embodiment, two second glass films G2a and G2b are obtained by cutting. Thus, two support rollers 54a and 54b are disposed.

The second roll-up portion 10 is disposed on a downstream side of the second conveying portion 8. More specifically, the second roll-up portion 10 rolls up the second glass films G2a and G2b conveyed by the second conveying portion 8 around winding cores 55a and 55b to thereby obtain the second glass rolls GRL2a and GRL2b. In this embodiment, two second glass films G2a and G2b are obtained by cutting. Thus, the two second glass rolls GRL2a and GRL2b are obtained by rolling up the two second glass films G2a and G2b, respectively.

As a material of the second glass films G2a and G2b (first glass film G1) to be manufactured by the manufacturing apparatus 1 having the above-mentioned configuration, silicate glass or silica glass is used. Borosilicate glass, soda-lime glass, aluminosilicate glass, or chemically tempered glass is preferably used, and alkali-free glass is most preferably used. The “alkali-free glass” as used herein refers to glass substantially free of an alkaline component (alkali metal oxide), and specifically refers to glass having a weight ratio of an alkaline component of 3,000 ppm or less. In the present invention, the weight ratio of the alkaline component is preferably 1,000 ppm or less, more preferably 500 ppm or less, most preferably 300 ppm or less.

In addition, the thickness dimensions of the second glass films G2a and G2b (in this embodiment, first glass film G1) are set to 10 μm or more and 300 μm or less, and is preferably 30 μm or more and 200 μm or less, most preferably 30 μm or more and 100 μm or less.

Now, a manufacturing method for the second glass films G2a and G2b (in this embodiment, second glass rolls GRL2a and GRL2b) through use of the manufacturing apparatus 1 having the above-mentioned configuration is described. This method comprises: a forming step S1; a both-end-portion removal step S2; a first roll-up step S3; a draw-out step S4; a cleavage step S5; and a second roll-up step S6.

In the forming step S1, as illustrated in FIG. 1, the molten glass GM overflowing from the overflow groove 11a of the forming body 11 in the forming portion 2 is caused to flow down along both side surfaces of the forming body 11 to be joined at a lower end of the forming body 11, to thereby form the molten glass GM into a film shape. At this time, the shrinkage of the molten glass GM in a width direction is controlled with the edge rollers 12, and thus the base glass film G having a predetermined width is formed. After that, strain removal treatment is performed on the base glass film G with the annealer 13 (annealing step). The base glass film G having a predetermined thickness is formed through a tension applied by the support rollers 15.

In the both-end-portion removal step S2, in the same manner as illustrated in FIG. 1, while the base glass film G is sent to a downstream side by the direction conversion portion 3 and the first conveying portion 4, part of the base glass film G is heated through irradiation with the laser beam L by the laser irradiation device 17a in the first cutting portion 5. After that, the refrigerant R is jetted to the heated site by the cooling device 17b. With this, a thermal stress is generated in the base glass film G. Initial cracks formed in the base glass film G in advance are developed through the thermal stress. With this, both end portions in the width direction are removed from the base glass film G. Thus, the first glass film G1 is formed.

In the subsequent first roll-up step S3, in the same manner as illustrated in FIG. 1, the first glass film G1 is rolled up around the winding core 18, to thereby form the first glass roll GRL1. After that, the first glass roll GRL1 is transferred to the draw-out portion 7. In the draw-out step S4, the first glass film G1 is drawn out from the first glass roll GRL1 having been transferred to the draw-out portion 7, and is conveyed to the second cutting portion 9 by the second conveying portion 8.

In the cutting step S5, the part of the first glass film G1 passing through the cutting zones 21 on the second conveying portion 8 is irradiated with laser beams L by the laser irradiation devices 45 in the cutting zones 21. In addition, the refrigerant R is sprayed onto irradiated areas to thereby cut the first glass film G1 in the direction along the conveying direction X. At this time, among the plurality of upstream-side belt conveyors 22a to 22g forming the upstream-side conveyor 19, for the upstream-side belt conveyor 22d corresponding to the center position in the width direction of the first glass film G1, air is discharged from the air-discharge space 37 inside the second support member 36 by the blowers 40a and 40b, thereby generating the negative pressure inside the air-discharge space 37. In this manner, the downward attraction force acts on the first glass film G1 on the first belt 23d through the groove portions 42, the hole portions 43, and the through holes 44 (see FIG. 4). Thus, the first glass film G1 is conveyed along the conveyance direction X under a state of being attracted to the first belt 23d of the upstream-side belt conveyor 22d.

Further, at this time, the upstream-side belt conveyor 22d having the attraction structure is configured to be capable of changing the attraction forces P11 and P12 with respect to the first glass film G1 in the conveyance direction X of the first glass film G. Specifically, adjustment is made such that, when seen in the conveyance direction X of the first glass film G1, the attraction force P12 with respect to the first glass film G1 is relatively smaller on the side close to the second cutting portion 9 and that the attraction force P11 with respect to the first glass film G1 is relatively larger on the side far from the second cutting portion 9 (see FIG. 4 and FIG. 5). Thus, on the upstream side with respect to the second cutting portion 9, the first glass film G1 is strongly attracted so that the first glass film G1 is conveyed to the second cutting portion 9 without misalignment. Further, even when deformation such as formation of wrinkles has occurred at the time of the strong attraction, with the attraction force P12 being set to be relatively smaller in the region on the downstream side with respect to the location in which the deformation such as formation of wrinkles has occurred and on the upstream side with respect to the second cutting portion 9, the deformation such as formation of wrinkles that has once occurred is eliminated or reduced before arrival at the second cutting portion 9. In this manner, the first glass film G1 is loaded to the second cutting portion 9 in the state of having no misalignment and no deformation such as formation of wrinkles.

The remaining upstream-side belt conveyors 22a to 22c and 22e to 22g are configured to be not capable of attracting the first glass film G1 to the first belts 23a to 23c and 23e to 23g as mentioned above. Thus, the first glass film G1 is conveyed along the conveyance direction X under a state of being held in contact with and supported by the first belts 23a to 23c and 23e to 23g.

In the cutting step S5, while the first glass film G1 is conveyed in the predetermined conveyance direction X by the upstream-side belt conveyors 22a to 22g as described above, the first glass film G1 is irradiated with the plurality of laser beams L from the laser irradiation portions of the laser irradiation device 45 (laser irradiation step).

The above-mentioned irradiation with the laser beams L heats the first glass film G1. After that, when the heated portions of the first glass film G1 reach positions immediately below the cooling device 46, the portions are exposed to the refrigerant R spayed downward from the cooling device 46 to be cooled. Expansion resulting from local heating performed by the laser irradiation device 45 and contraction resulting from cooling performed by the cooling device 46 cause thermal stress in the first glass film G1. The first glass film G1 has initial cracks formed in advance by means that is not shown. When the initial cracks are developed by making use of the above-mentioned thermal stress, the first glass film G1 are continuously cut (cleaved) at predetermined positions in the width direction. Further, in this embodiment, through the laser cutting at three positions in the width direction, both end portions of the first glass film G1 in the width direction are cut off, and two second glass films G2a and G2b, each having a predetermined dimension in the width direction, are obtained by cutting (see FIG. 2). The second glass films G2a and G2b are conveyed by the downstream-side conveyor 20 located on the downstream side of the cutting zones 21 in the conveying direction X toward the second roll-up portion 10 located on the downstream side of the downstream-side conveyor 20 in the conveying direction X.

At this time, the plurality of downstream-side belt conveyors 27a to 27g forming the downstream-side conveyor 20 have the structure capable of attracting the second glass films G2a and G2b to be supported and conveyed (see FIG. 2). With this structure, the second glass films G2a and G2b are conveyed along the conveyance direction X under a state of being attracted to the second belts 28c to 28f of the downstream-side belt conveyors 27c to 27f.

In the second roll-up step S6, the second glass films G2a and G2b are rolled up around the winding cores 55a and 55b disposed at predetermined positions, respectively. After the second glass films G2a and G2b, each having a predetermined length, are rolled up, the second glass rolls GRL2a and GRL2b are obtained.

Further, in this embodiment, the support rollers 54a and 54b serving as the spacing portion 53 are disposed between the downstream-side conveyor 20 and the second roll-up portion 10. Thus, the second glass films G2a and G2b passing over the support rollers 54a and 54b are conveyed to the downstream side while being deformed (deformed so as to curve in a direction of protruding upward in this case) in conformity with outer peripheral surface shapes of the support rollers 54a and 54b. As a result, a predetermined gap in the width direction is defined by the second glass films G2a and G2b immediately after cutting. Thus, the second glass films G2a and G2b can be conveyed to the second roll-up portion 10 while preventing interference between their cut surfaces.

As described above, in the manufacturing method for a glass film (second glass films G2a and G2b) according to this embodiment, at least a part of the upstream-side belt conveyors 22a to 22g located on the upstream side in the conveyance direction X of the first glass film G1 with respect to the second cutting portion 9 (upstream-side belt conveyor 22d corresponding to the center in the width direction of the first glass film G1) has the structure capable of attracting the first glass film G1 to the first belt 23d, and the attraction forces P11 and P12 with respect to the first glass film G1 on the upstream-side belt conveyor 22d can be changed in the conveyance direction X of the first glass film G1. With such configuration, the first glass film G1 can be conveyed while being attracted by attraction forces having appropriate magnitudes depending on positions in the conveyance direction X. Thus, when there is a location in which the first glass film G1 is excessively strongly attracted, the attraction force in that location is set to be smaller so that deformation such as formation of wrinkles can be prevented or suppressed as much as possible. Meanwhile, with regard to other locations, for example, with the attraction force being set to be relatively larger so that slippage of the first glass film G1 with respect to the first belt 23d (specifically, attraction surface 23d1) is prevented, thereby being capable of conveying the first glass film G1 without misalignment. Thus, accurate cutting of the first glass film G1 can be stably performed, and a high-quality product glass roll (second glass rolls GRL2a and GRL2b) can be stably provided.

Further, in this embodiment, the attraction surface 23d1 of the first belt 23d is divided into the two attraction zones Z11 and Z12 capable of varying the attraction forces P11 and P12 with respect to the first glass film G1 in predetermined regions in the conveyance direction X of the first glass film G1. Further, in this case, magnitudes of the attraction forces P11 and P12 in the attraction zones Z11 and Z12 are controlled such that the attraction force P11 in the first attraction zone Z11 of the attraction surface 23d1 located on the upstream side in the conveyance direction X is set to be relatively larger and that the attraction force P12 in the second attraction zone Z12 of the attraction surface 23d1 located on the downstream side in the conveyance direction X of the first glass film G1 with respect to the first attraction zone Z11 is set to be relatively smaller. Through such control of the attraction forces P11 and P12, the first glass film G1 can be attracted relatively stronger on the upstream side in the conveyance direction X, thereby being capable of conveying the first glass film G1 to the second cutting portion 9 without misalignment. Further, even when deformation such as formation of wrinkles has occurred at the time of strongly attracting the first glass film G1 in the first attraction zone Z11, with the attraction force P12 being set to be relatively smaller in the region on the downstream side in the conveyance direction X with respect to the location in which the deformation such as formation of wrinkles has occurred, the deformation such as formation of wrinkles that has once occurred can be eliminated or reduced. In this manner, the first glass film G1 can be conveyed under a state of having no misalignment and no deformation such as formation of wrinkles, thereby being capable of stably performing high-quality manufacture-related processing even in the case in which the second cutting portion 9 is arranged on the downstream side in the conveyance direction X with respect to the second attraction zone Z12. Further, it is only required that the attraction forces P11 and P12 be set for the two attraction zones Z11 and Z12, and hence the attraction force distribution can be easily set or changed.

In the above, the manufacturing method and the manufacturing apparatus for a glass film according to one embodiment of the present invention are described. However, as a matter of course, the manufacturing method and the manufacturing apparatus may be implemented in suitable modes within the scope of the present invention.

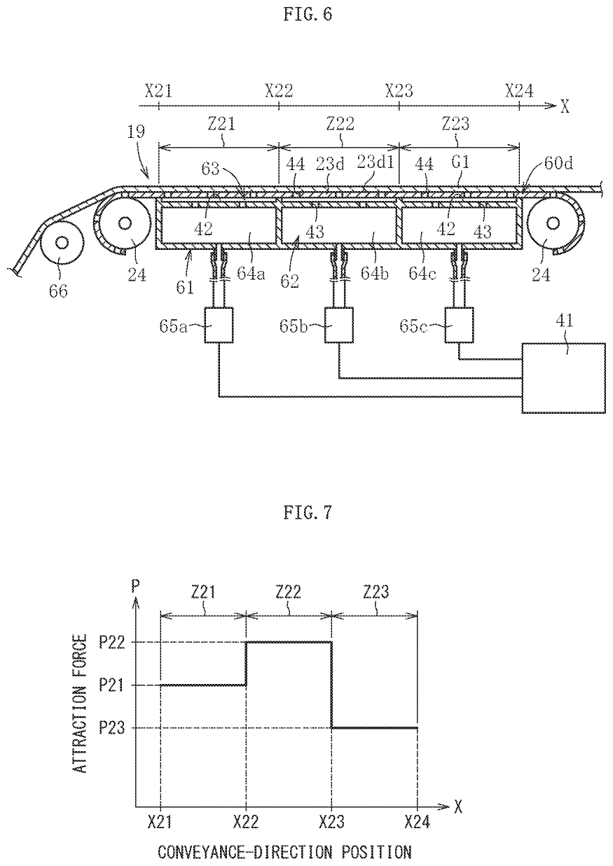

FIG. 6 is a main-part sectional view of an upstream-side belt conveyor 60d according to a second embodiment of the present invention. Similarly to the first embodiment of the present invention, the upstream-side belt conveyor 60d forms the upstream-side conveyor 19 of the second conveying portion 8 together with the remaining upstream-side belt conveyors 22a to 22c and 22e to 22g. Further, similarly to the upstream-side belt conveyor 22d according to the first embodiment, the upstream-side belt conveyor 60d comprises the endless strip-shaped first belt 23d, the plurality of pulleys 24, the first support member 25, and the drive source 26 (see FIG. 2 and FIG. 3), and further comprises: a second support member 61 configured to support the first belt 23d from below; an air-discharge space 62 defined inside the second support member 61; and a communication portion 63 configured to allow communication between the air-discharge space 62 and a space defined between the first belt 23d and the second support member 61. Further, the air-discharge space 62 is defined inside the second support member 61.

In this embodiment, the air-discharge space 62 is partitioned into three spaces (first partitioned space 64a, second partitioned space 64b, and third partitioned space 64c) in the conveyance direction X of the first glass film G1. In this case, the partitioned spaces 64a to 64c are connected to blowers 65a to 65c, respectively, each serving as an air-discharge device. The plurality of blowers 65a to 65c can be independently controlled by the controller 41. A configuration of the communication portion 63 is the same as the configuration of the communication portion of the first embodiment (groove portions 42, hole portions 43, and through holes 44), and hence description thereof is omitted.

With the upstream-side belt conveyor 60d having the attraction structure having the configuration described above, through discharge of air from the corresponding partitioned spaces 64a to 64c by driving of the blowers 65a to 65c, the downward suction force acts on the first glass film G1 on the first belt 23d through the communication portion 63 (groove portions 42, hole portions 43, and through holes 44), thereby being capable of attracting the first glass film G1 to the attraction surface 23d1 of the first belt 23d. Further, as mentioned above, when the air-discharge space 62 is partitioned into three spaces in the longitudinal direction of the first glass film G1, the attraction surface 23d1 of the first belt 23d is divided into three attraction zones Z21 to Z23 which are capable of varying the attraction forces with respect to the first glass film G1 in predetermined regions in the conveyance direction X of the first glass film G1. In this case, the attraction zones Z21 to Z23 are set to positions and sizes corresponding to the partitioned spaces 64a to 64c located therebelow. In this embodiment, as illustrated in FIG. 6, the positions and sizes of the partitioned spaces 64a to 64c are set such that a dimension of the first attraction zone Z21 in a direction along the conveyance direction X, a dimension of the second attraction zone Z22 in the direction along the conveyance direction X, and a dimension of the third attraction zone Z23 in the direction along the conveyance direction X are equal to each other. Further, although illustration is omitted, the positions and sizes of the partitioned spaces 64a to 64c are set such that a width-direction dimension of the first attraction zone Z21, a width-direction dimension of the second attraction zone Z22, and a width-direction dimension of the third attraction zone Z23 are equal to each other.

The upstream-side belt conveyor 60d having the above-mentioned attraction structure is configured to be capable of changing the attraction forces with respect to the first glass film G1 in the conveyance direction X of the first glass film G1. As in this embodiment, when the blowers 65a to 65c are connected for the partitioned spaces 64a to 64c, respectively, and the blowers 65a to 65c are configured to be controllable by the controller 41, for example, through adjustment of outputs (air-discharge amounts) of the blowers 65a to 65c by the controller 41, the negative pressure inside the partitioned spaces 64a to 64c as well as the attraction forces P21 to P23 with respect to the first glass film G1 (see FIG. 7) are set independently for the attraction zones Z21 to Z23 formed above the partitioned spaces 64a to 64c. Thus, through adjustment of the outputs of the blowers 65a to 65c by the controller 41, control is made such that the attraction forces P21 to P23 with respect to the first glass film G1 vary among the three attraction zones Z21 to Z23.

FIG. 7 is a graph for showing a relationship between the attraction zones Z21 to Z23 and attraction forces P21 to P23 according to this embodiment. As illustrated in FIG. 7, when the upstream-side belt conveyor 60d has the above-mentioned configuration, the drive control on the blowers 65a to 65c by the controller 41 is performed such that, for example, the attraction force P22 that acts on the first glass film G1 in the second attraction zone Z22 formed at an intermediate position in the conveyance direction X of the first glass film G1 is the largest, the attraction force P21 that acts on the first glass film G1 in the first attraction zone Z21 formed on the most upstream side in the conveyance direction X is the second largest, and the attraction force P23 that acts on the first glass film G1 in the third attraction zone Z23 formed on the most downstream side in the conveyance direction X is the smallest. In this case, it is preferred that a difference between the attraction force P22 in the second attraction zone Z22 and the attraction force P21 in the first attraction zone Z21 be from 0.2 kPa to 0.5 kPa. Further, it is preferred that a difference between the attraction force P21 in the first attraction zone Z21 and the attraction force P23 in the third attraction zone Z23 be from 0.8 kPa to 1.1 kPa. Also in this embodiment, the attraction force P21 is set to a constant magnitude in a corresponding section from a position X21 to a position X22 in the conveyance direction X, the attraction force P22 is set to a constant magnitude in a corresponding section from the position X22 to a position X23, and the attraction force P23 is set to a constant magnitude in a corresponding section from the position X23 to a position X24.

As described above, also in this embodiment, the attraction structure is provided to the upstream-side belt conveyor 60d located on the upstream side in the conveyance direction X of the first glass film G1 with respect to the second cutting portion 9, and the attraction forces P21 to P23 can be changed in the conveyance direction X of the first glass film G1. Thus, the first glass film G1 can be conveyed to the second cutting portion 9 without misalignment while preventing deformation such as formation of wrinkles.

Further, in this embodiment, when the attraction surface 23d1 of the first belt 23d is divided into the three attraction zones Z21 to Z23, among the attraction forces P21 to P23 in the three attraction zones Z21 to Z23, the attraction force P22 in the second attraction zone Z22 located in the middle in the conveyance direction is set to be the largest, and the attraction forces P21 and P23 in the third attraction zone Z23 on the downstream side in the conveyance direction X with respect to the attraction zone Z22 and the first attraction zone Z21 on the upstream side in the conveyance direction X are each set to be smaller than the attraction force P22 in the second attraction zone Z22. For example, in a case in which the first glass film G1 is drawn out from the first glass roll GRL1, and as illustrated in FIG. 6, is transferred and placed onto the upstream-side belt conveyor 60d (upstream-side conveyor 19) via the support rollers 66 from an obliquely lower side, when the first glass film G1 is strongly attracted immediately after the transfer and placement, the deformation such as formation of wrinkles is liable to occur in some cases. Thus, when the attraction force P21 in the first attraction zone Z21 on the most upstream side is set to be smaller than the attraction force P22 in the second attraction zone Z22 located on the downstream side with respect to the first attraction zone Z21, occurrence of the deformation such as formation of wrinkles immediately after the above-mentioned transfer and placement can be prevented. Accordingly, the first glass film G1 can be conveyed to the second cutting portion 9 under a state of having no deformation such as formation of wrinkles in the first glass film G1 after the transfer and placement. Further, while the first glass film G1 is strongly attracted in the second attraction zone Z22 so that the first glass film G1 is conveyed without misalignment, when the attraction force P23 in the third attraction zone Z23 located on the downstream side in the conveyance direction X with respect to the second attraction zone Z22 is set to be smaller than the attraction force P22 in the second attraction zone Z22 (set to be smaller than the attraction force P21 in the first attraction zone Z21 in this embodiment), even when the deformation such as formation of wrinkles has newly occurred in the second attraction zone Z22, the deformation such as formation of wrinkles can be eliminated or reduced. In this manner, the first glass film G1 can be conveyed under a state of having no misalignment and no deformation such as formation of wrinkles, thereby being capable of stably performing high-quality manufacture-related processing in the case in which the second cutting portion 9 is arranged on the downstream side in the conveyance direction X with respect to the third attraction zone Z23.

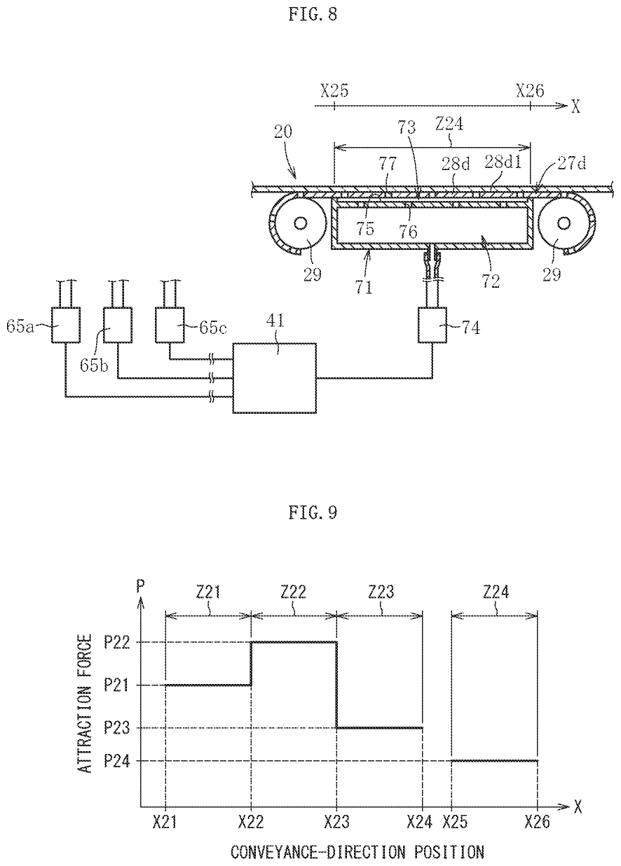

FIG. 8 is a main-part sectional view of an attraction-force control system for a conveying device according to a third embodiment of the present invention, and representatively show a main-part sectional view (main-part sectional view taken along the cutting line B-B of FIG. 2) of, among the downstream-side belt conveyors 27a to 27g, the downstream-side belt conveyor 27d located at the center in the width direction. Similarly to the remaining downstream-side belt conveyors 27a to 27c and 27e to 27g, the downstream-side belt conveyor 27d comprises: a second support member 71 configured to support the endless second belt 28d from below; an air-discharge space 72 defined inside the second support member 71; and a communication portion 73 configured to allow communication between the air-discharge space 72 and a space defined between the second belt 28d and the second support member 71.

Here, one air-discharge space 72 is present inside the second support member 71, and is connected to the blower 74 serving as an air-discharge device. The blower 74 is controllable by the controller 41 independently from the plurality of other blowers 65a to 65c.

Further, in this case, the communication portion 73 comprises: one or a plurality of groove portions 75, which are formed in an upper surface of the second support member 71, and extend in the longitudinal direction of the second belt 28d; hole portions 76, which are formed in the second support member 71, and allow communication between the groove portions 75 and the air-discharge space 72; and a plurality of through holes 77, which are formed in the second belt 28d, and are formed at positions overlapping the groove portions 75 in the width direction of the second belt 28d. Thus, through discharge of air from the air-discharge space 72 by driving of the blower 74, the downward suction force acts on the second glass film G2a on the second belt 28d through the groove portions 75, the hole portions 76, and the through holes 77, thereby being capable of attracting the second glass film G2a to the second belt 28d. Accordingly, a part of the surface of the second belt 28d passing above the air-discharge space 72 functions as the attraction surface 28d1 with respect to the second glass film G2a. In this case, a fourth attraction zone Z24 on the second belt 28d is set to a position and a size corresponding to the air-discharge space 72 located therebelow. The remaining downstream-side belt conveyors 27a to 27c and 27e to 27g also have the above-mentioned attraction structure.

The downstream-side belt conveyors 27a to 27g having the above-mentioned attraction structure and the upstream-side belt conveyor 60d are configured to be capable of changing the attraction forces with respect to the glass films G1, G2a, and G2b in the conveyance direction X of the glass films G1, G2a, and G2b having both end portions in the width direction cut therefrom. As in the second embodiment, when the air-discharge space 62 of the upstream-side belt conveyor 60d is partitioned into the partitioned spaces 64a to 64c, and the blowers 65a to 65c and 74 are connected for the partitioned spaces 64a to 64c and the air-discharge space 72 (see FIG. 6 and FIG. 8), and the blowers 65a to 65c and 74 are configured to be controllable by the controller 41, for example, through adjustment of outputs (air-discharge amounts) of the blowers 65a to 65c and 74 by the controller 41, the negative pressure inside the partitioned spaces 64a to 64c and the air-discharge space 72 as well as the attraction forces with respect to the glass films G1, G2a, and G2b are set independently for the attraction zones Z21 to Z24 formed above the partitioned spaces 64a to 64c and the air-discharge space 72. Thus, through adjustment of the outputs of the blowers 65a to 65c and 74 by the controller 41, the attraction forces with respect to the glass films G1, G2a, and G2b are controlled so as to vary among the four attraction zones Z21 to Z24.

FIG. 9 is a graph for showing a relationship between the attraction zones Z21 to Z24 and the attraction forces P21 to P24 according to this embodiment. As shown in FIG. 9, when the upstream-side belt conveyor 60d and the downstream-side belt conveyors 27a to 27g have the above-mentioned configuration, drive control on the blowers 65a to 65c and 75 is performed by the controller 41 such that, for example, the attraction force P22 that acts on the glass film G1, G2a, G2b in any one of the first to third attraction zones Z21 to Z23 (here, second attraction zone Z22) on the first belt conveyor 60d is the largest, and the attraction force P24 that acts on the glass film G1, G2a, G2b in the attraction zone Z24 on the downstream-side belt conveyors 28a to 28g located on the downstream side in the conveyance direction X with respect to the third attraction zone Z23 is the smallest. When the attraction force P24 in the attraction zone Z24 is set to be the smallest, while rubbing of end surfaces due to flapping of the glass film G1, G2a, G2b after cutting is prevented, the influence of the suction force P24 on the second cutting portion 9 can be prevented. Also in this embodiment, the attraction force P21 is set to a constant magnitude in a corresponding section from the position X21 to the position X22 in the conveyance direction X, the attraction force P22 is set to a constant magnitude in a corresponding section from the position X22 to the position X23, the attraction force P23 is set to a constant magnitude in a corresponding section from the position X23 to the position X24, and the attraction force P24 is set to a constant magnitude in a corresponding section from a position X25 to a position X26 in the conveyance direction X.

As described above, in this embodiment, the attraction structure is provided to each of the upstream-side belt conveyor 60d and the downstream-side belt conveyors 27a to 27g, and the attraction forces P21 to P24 can be changed in the conveyance direction X of the glass film G1, G2a, G2b having both end portions thereof in the width direction cut therefrom. Thus, before and after the cutting by the second cutting portion 9, the glass film G1, G2a, G2b can be conveyed without misalignment while preventing the deformation such as formation of wrinkles.

When the attraction forces P21 to P24 satisfy the magnitude relationship shown in FIG. 9, it is preferred that a difference between the attraction force P22 in the second attraction zone Z22 and the attraction force P21 in the first attraction zone Z21 be from 0.2 kPa to 0.5 kPa. Further, it is preferred that a difference between the attraction force P21 in the first attraction zone Z21 and the attraction force P23 in the third attraction zone Z23 be from 0.8 kPa to 1.1 kPa. Similarly, it is preferred that magnitudes of the attraction forces P23 and P24 be set such that the attraction force P23 in the third attraction zone Z23 and the attraction force P24 in the fourth attraction zone Z24 are from 0.01 kPa to 0.1 kPa.

There has been exemplified a case in which, when the attraction surface 23d1 is divided into the plurality of attraction zones Z11 and Z12 (Z21 to Z23), the dimensions of the attraction zones Z11 and Z12 (Z21 to Z23) in the conveyance direction X are set equal, and the width-direction dimensions are set equal. However, the present invention is not limited to such configuration. For example, although illustration is omitted, in the upstream-side belt conveyor 60d illustrated in FIG. 6, the dimension of the second attraction zone Z22 in the direction along the conveyance direction X may be set to be larger than dimensions of any of the remaining attraction zones Z21 and Z23 in the direction along the conveyance direction X. In this case, there is an advantage that the attraction force P22 in the second attraction zone Z22 can be set to be smaller than the attraction force P22 in the second attraction zone Z22 given in the case illustrated in FIG. 6. The same configuration is possible also in the case in which the attraction surface 28d1 is divided into a plurality of attraction zones.

Further, in the embodiments described above, there has been exemplified a case in which the attraction surface 23d1 of the first belt 23d is divided into the two attraction zones Z11 and Z12 or into the three attraction zones Z21 to Z23 in the conveyance direction X of the first glass film G1. However, as a matter of course, the present invention is not limited to such configuration. The attraction surface 23d1 may be divided into four or more attraction zones as needed. In this case, the corresponding air-discharge space is partitioned into four or more spaces.

Further, the relationship between the attraction zones Z11 and Z12 (Z21 to Z23) and the attraction forces P11 and P12 (P21 to P23) as shown in FIG. 5 and FIG. 7 or the relationship between the attraction zones Z21 to Z24 and the attraction forces P21 to P24 as shown in FIG. 9 are mere examples. The number of the attraction zones and the attraction forces therein may suitably be set in accordance with, for example, a material, a dimension, a shape, or a content of processing other than cutting with regard to a glass film to be conveyed.

Further, in the embodiments described above, there has been exemplified a case in which the attraction forces with respect to the first glass film G1 change in a stepwise manner at positions in the conveyance direction. However, as a matter of course, the attraction forces may be set so as to achieve the attraction force distribution other than such distribution. For example, although illustration is omitted, the attraction force distribution may be set such that the attraction forces change linearly (in a predetermined gradient) among predetermined regions along the conveyance direction. Further, the attraction force distribution may be set such that the attraction forces act intermittently. As a matter of course, the attraction structure may be changed in accordance with the attraction force distribution. That is, in order to achieve a desired attraction force distribution, there may be employed any attraction structure other than the structure in which the air-discharge space 37 is defined inside the second support member 36 and the air-discharge space 37 is partitioned as illustrated in FIG. 4 and other drawings.

Further, in the embodiments described above, there has been exemplified a case in which the attraction structure according to the present invention is applied only to the predetermined upstream-side belt conveyor 22d among the upstream-side belt conveyors 22a to 22g forming the upstream-side conveyor 19. However, as a matter of course, the attraction structure according to the present invention may be applied to a belt conveyor other than the upstream-side belt conveyor 22d. For example, although illustration is omitted, the attraction structure according to the present invention may be applied to two or more belt conveyors among the upstream-side belt conveyors 22a to 22g.

Further, there has been exemplified a case in which the second surface plate 50 is arranged in the cutting zone 21 for the first glass film G1 and the first surface plate 47 is arranged at a position apart from the cutting zone 21 in the width direction. However, as a matter of course, the present invention is not limited to this arrangement. As long as there is no significant influence on the laser cutting, a third conveyor (not shown) may be arranged so that the support conveyance surface passes through the cutting zone 21, and at least one of the first surface plate 47 or the second surface plate 50 may be omitted.

Further, it is not always required that the support conveyance surface of the conveying device (second conveying portion 8) be divided at the position corresponding to the cutting zone 21 in the conveyance direction X. For example, the support conveyance surface of the second conveying portion 8 may be divided at a position shifted from the cutting zone 21 on the downstream side in the conveyance direction X.

There has been exemplified a case in which both of the upstream-side conveyer 19 and the downstream-side conveyor 20 obtained by partitioning the second conveying portion 8 serving as the conveying device at the cutting zones 21 are belt conveyors. However, as a matter of course, the upstream-side conveyor 19 and the downstream-side conveyor 20 may have other shapes and forms. For example, the downstream-side conveyor 20 may be a roller conveyor or other various types of conveying devices.

Further, there has been exemplified a case in which the second conveying portion 8 comprises the two conveyors 19 and 20 in the conveyance direction X. However, as a matter of course, the present invention is not limited to this configuration. For example, the second conveying portion 8 may comprise one belt conveyor over its entire region in the conveyance direction X with the cutting zone 21 provided on the belt conveyor, and the attraction structure according to the present invention may be applied.

Further, there has been exemplified a case in which the second conveying portion 8 comprises the plurality of upstream-side belt conveyors 22a to 22g which are adjacent to each other in the width direction of the first glass film G1 and the plurality of downstream-side belt conveyors 27a to 27g which are adjacent to each other in the width direction of the first glass film G1. However, as a matter of course, a configuration other than this may be employed. For example, the upstream-side conveyor 19 may comprise one belt conveyor, and the attraction structure according to the present invention may be applied to the one belt conveyor. Alternatively, the downstream-side conveyor 20 may comprise one belt conveyor.

Further, there has been exemplified a case in which the two second glass films G2a and G2b are cut out from one first glass film G1. However, as a matter of course, the present invention can also be applied to a case in which one second glass film G2a having a different width-direction dimension is cut out. Further, the present invention can also be applied to a case in which three or more second glass films G2a are cut out.

Further, there has been described a case in which the present invention is used for the first glass film G1 obtained by cutting off both end portions of the base glass film G in the width direction with use of the first cutting portion 5. However, the present invention may be applicable to cutting of the base glass film G with use of the first cutting portion 5. In this case, the present invention can be carried out when the first conveying portion 4 has the same configuration as that of the second conveying portion 8 illustrated in FIG. 2 and other drawings. Further, for the first cutting portion 5 and the second cutting portion 9, a configuration that enables cutting other than laser cutting can also be employed.

Further, there has been exemplified a case in which the cutting processing in the direction along the longitudinal direction is performed as the manufacture-related processing on the glass film. However, as a matter of course, the belt conveyor according to the present invention can also be applied to processing other than such cutting processing, for example, to processes for performing suitable manufacture-related processing such as coating or filming, or lamination, as long as such processing is to be performed in the course of from formation of the glass film to shipping of a final product in a state of performing conveyance with the belt conveyor.

There has been described a case in which the present invention is used for the first glass film G1 having a strip shape. However, as a matter of course, the present invention can also be used for the first glass film having other shapes. That is, although illustration is omitted, the present invention can be applied to a plate glass (glass film) having a rectangular sheet shape or the like. Further, it is not always required that the second glass film G2a obtained by cutting be rolled into a roll shape. In other words, the present invention can also be applied to a manufacturing process for a second glass film G2a which is not to be rolled into a roll shape.

### REFERENCE SIGNS LIST

1 manufacturing apparatus for a glass roll
2 forming portion
3 direction conversion portion
4 first conveying portion
5 first cutting portion
8 second conveying portion
9 second cutting portion
11 forming body
17a laser irradiation device
17b cooling device
19 upstream-side conveyor
20 downstream-side conveyor
21 cutting zone
22a to 22g, 60d upstream-side belt conveyor
23a to 23g first belt
24, 29 pulley
25, 30 first support member
26, 31 drive source
27a to 27g downstream-side belt conveyor
28a to 28g second belt
32 rail portion
33 sliding portion
36, 61, 71 second support member
37, 62, 72 air-discharge space
38, 63, 73 communication portion
39a, 39b, 64a to 64c partitioned space
40a, 40b, 65a to 65c, 74 blower
41 controller
42, 75 groove portion
43, 76 hole portion
44, 77 through hole
45 laser irradiation device
46 cooling device
47 first surface plate
48 first support surface
49 first suction portion
50 second surface plate
51 second support surface
52 second suction portion
G, G1, G2a, G2b glass film
GRL1, GRL2a, GRL2b glass roll
L laser beam
R refrigerant
P11, P12, P21 to P24 attraction force
X conveyance direction
Z11, Z12, Z21 to Z24 attraction zone

1. A manufacturing method for a glass film, comprising, while conveying a glass film with a belt conveyor, performing manufacture-related processing on the glass film with a manufacture-related-processing unit,
wherein the belt conveyor is configured to be capable of attracting the glass film to a belt on an upstream side in a conveyance direction of the glass film with respect to the manufacture-related-processing unit, and
wherein the belt conveyor is configured to be capable of changing attraction forces with respect to the glass film in the conveyance direction of the glass film.

2. The manufacturing method for a glass film according to claim 1, wherein, when viewed in the conveyance direction of the glass film, an attraction force with respect to the glass film is relatively smaller on a side close to the manufacture-related-processing unit, and an attraction force with respect to the glass film is relatively larger on a side far from the manufacture-related-processing unit.

3. The manufacturing method for a glass film according to claim 1, wherein an attraction surface of the belt capable of attracting the glass film is divided into a plurality of attraction zones capable of varying attraction forces with respect to the glass film in predetermined regions in the conveyance direction of the glass film.

4. The manufacturing method for a glass film according to claim 3, wherein the attraction surface is divided into two attraction zones in the conveyance direction of the glass film.

5. The manufacturing method for a glass film according to claim 4, wherein magnitudes of the attraction forces in the attraction zones are controlled such that the attraction force in a first attraction zone of the attraction surface located on an upstream side in the conveyance direction of the glass film is relatively larger and that the attraction force in a second attraction zone of the attraction surface located on a downstream side in the conveyance direction of the glass film with respect to the first attraction zone is relatively smaller.

6. The manufacturing method for a glass film according to claim 3, wherein the attraction surface is divided into three attraction zones in the conveyance direction of the glass film.

7. The manufacturing method for a glass film according to claim 6, wherein, when the three attraction zones comprise a first attraction zone, a second attraction zone, and a third attraction zone which are arranged in the stated order from an upstream side toward a downstream side in the conveyance direction of the glass film, magnitudes of the attraction forces in the attraction zones are controlled such that the attraction force in the second attraction zone is the largest and that the attraction forces in the first attraction zone and the third attraction zone are each smaller than the attraction force in the second attraction zone.

8. The manufacturing method for a glass film according to claim 3,
wherein the belt conveyor further comprises a support member having a hollow shape and being configured to support the belt,
wherein the support member comprises therein an air-discharge space capable of discharging air, and the air-discharge space is partitioned so as to correspond to the attraction zones in the conveyance direction of the glass film, and
wherein the support member and the belt comprise a communication portion configured to allow communication between the air-discharge space and a space defined between the belt and the support member.

9. The manufacturing method for a glass film according to claim 8, wherein blowers which are independently controllable are connected to partitioned spaces defined by partitioning the air-discharge space, respectively.

10. The manufacturing method for a glass film according to claim 1,
wherein the belt conveyor comprises an upstream-side belt conveyor located relatively on an upstream side in the conveyance direction of the glass film, and
wherein a downstream-side conveyor is arranged on a downstream side in the conveyance direction of the glass film with respect to the upstream-side belt conveyor.

11. The manufacturing method for a glass film according to claim 1, wherein the manufacture-related-processing unit comprises a laser cutting unit capable of cutting the glass film along a longitudinal direction of the glass film.

12. A manufacturing apparatus for a glass film, comprising:
a belt conveyor configured to convey a glass film; and
a manufacture-related-processing unit configured to perform manufacture-related processing on the glass film being conveyed by the belt conveyor,
wherein the belt conveyor is configured to be capable of attracting the glass film to a belt on an upstream side in a conveyance direction of the glass film with respect to the manufacture-related-processing unit, and
wherein the belt conveyor is configured to be capable of changing an attraction force with respect to the glass film in the conveyance direction of the glass film.
